(19) United States
(12) Patent Application Publication
(10) Pub. No.: US 2025/0207491 A1
(43) Pub. Date: Jun. 26, 2025

(54) CONNECTION ASSEMBLY FOR A FLUID SUPPLY SYSTEM

(71) Applicant: Scout Surface Solutions, LLC, Joshua, TX (US)

(72) Inventors: Thomas George Roesner, Cypress, TX (US); David Lane Evans, Conroe, TX (US); Jason Thetford, Cleburne, TX (US); John Paul Stratton, Alvarado, TX (US)

(21) Appl. No.: 19/079,607

(22) Filed: Mar. 14, 2025

Related U.S. Application Data
(63) Continuation of application No. PCT/US23/32743, filed on Sep. 14, 2023.
(60) Provisional application No. 63/406,594, filed on Sep. 14, 2022.

(51) Int. Cl. E21B 43/26; F16L 3/00; F16L 33/00

(52) U.S. Cl. CPC E21B 43/2607; F16L 3/00; F16L 33/00

(57) ABSTRACT

A connection assembly for a fluid supply system includes a high-pressure flow passage having a first end and a second end. The first end is configured to couple to a high-pressure inlet of a high-pressure conduit assembly, and the high-pressure flow passage includes a high-pressure flexible hose and/or a high-pressure pipe assembly. The connection assembly also includes a cart assembly having a cart and an interface assembly. The interface assembly is coupled to the cart, and the interface assembly is configured to couple to the second end of the high-pressure flow passage such that the cart assembly and the high-pressure conduit assembly support an entirety of the high-pressure flow passage above a ground surface.

### CROSS-REFERENCE TO RELATED APPLICATION

This application is a continuation of International Application No. PCT/US23/32743, entitled “CONNECTION ASSEMBLY FOR A FLUID SUPPLY SYSTEM,” filed Sep. 14, 2023, which claims priority from and the benefit of U.S. Provisional Application Ser. No. 63/406,594, entitled “CONNECTION ASSEMBLY FOR A FLUID SUPPLY SYSTEM”, filed Sep. 14, 2022. Each of the foregoing applications is incorporated by reference in its entirety.

### BACKGROUND

The present disclosure relates generally to a connection assembly for a fluid supply system.

Various resources (e.g., hydrocarbon gas, oil, etc.) may be extracted from subterranean formations by drilling wells into the subterranean formations. During production, one or more resources may flow from the subterranean formation to a wellhead via the well. The wellhead may include components (e.g., valves, connectors, etc.) configured to control flow of the one or more resources to storage and/or processing assemblies.

For a subterranean formation having low porosity and/or low permeability, and/or when flow of the one or more resources from a subterranean formation decreases, a well stimulation system may be employed to perform a well stimulation operation to fracture the subterranean formation, thereby increasing the flow of the one or more resources from the subterranean formation. The well stimulation system typically includes a well stimulation fluid supply system and a well stimulation tree. The well stimulation fluid supply system includes a fluid source configured to output fracturing fluid (e.g., including water, sand, proppant, acid, chemicals, additives, etc.) and one or more pumps configured to significantly increase the pressure of the fracturing fluid. The well stimulation fluid supply system is configured to output the high-pressure fracturing fluid to the well stimulation tree. The well stimulation tree is coupled to the wellhead and configured to direct the high-pressure fracturing fluid through the wellhead and the well to the subterranean formation.

Certain well stimulation fluid supply systems include a fluid conduit assembly having multiple low-pressure conduits and a high-pressure conduit. The low-pressure conduits may be disposed on opposite lateral sides of the high-pressure conduit, and the low-pressure conduits may be fluidly coupled to an inlet manifold. The inlet manifold may be configured to receive the fracturing fluid from the fluid source and to provide the fracturing fluid to the low-pressure conduits. One or more low-pressure conduits positioned on a first lateral side of the high-pressure conduit may provide the fracturing fluid to a first set of pumps on the first lateral side of the high-pressure conduit, and one or more low-pressure conduits positioned on a second lateral side of the high-pressure conduit may provide the fracturing fluid to a second set of pumps on the second lateral side of the high-pressure conduit. The pumps may significantly increase the pressure of the fracturing fluid and output the high-pressure fracturing fluid to the high-pressure conduit. The high-pressure conduit, in turn, may output the high-pressure fracturing fluid to the well stimulation tree.

Each pump may be fluidly coupled to the high-pressure conduit by a respective high-pressure flexible hose. Each high-pressure flexible hose may have a length of about 20 feet (e.g., 6.10 m) to facilitate positioning the respective pump at a suitable location relative to the high-pressure conduit. In addition, each high-pressure flexible hose may be rated for a working pressure of greater than 10,000 psi. Due to the length and the pressure rating of each high-pressure flexible hose, each flexible hose may weigh about 600 pounds (e.g., 272.15 kg). As a result, a crane may be used to position each flexible hose for connection to the high-pressure conduit, thereby increasing the cost of equipment/equipment rental for assembling the fluid supply system. In addition, due to the length of each high-pressure flexible hose, the high-pressure flexible hose may have a significant cost, thereby further increasing the cost of assembling the fluid supply system. In addition, the costs associated with maintaining the fluid supply system may be increased due to the costs associated with periodically replacing used high-pressure flexible hoses.

### BRIEF DESCRIPTION

In certain embodiments, a connection assembly for a fluid supply system includes a high-pressure flow passage having a first end and a second end. The first end is configured to couple to a high-pressure inlet of a high-pressure conduit assembly, and the high-pressure flow passage includes a high-pressure flexible hose and/or a high-pressure pipe assembly. The connection assembly also includes a cart assembly having a cart and an interface assembly. The interface assembly is coupled to the cart, and the interface assembly is configured to couple to the second end of the high-pressure flow passage such that the cart assembly and the high-pressure conduit assembly support an entirety of the high-pressure flow passage above a ground surface.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an embodiment of a well stimulation system;

FIG. 2 is a block diagram of an embodiment of a well stimulation fluid supply system that may be employed within the well stimulation system of FIG. 1;

FIG. 3 is a perspective view of an embodiment of a connection assembly that may be employed within the well stimulation fluid supply system of FIG. 2;

FIG. 4 is a perspective view of another embodiment of a connection assembly that may be employed within the well stimulation fluid supply system of FIG. 2;

FIG. 5 is a perspective view of a further embodiment of a connection assembly that may be employed within the well stimulation fluid supply system of FIG. 2; and

FIG. 6 is a flowchart of an embodiment of a method of providing high-pressure fluid to a high-pressure conduit assembly.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

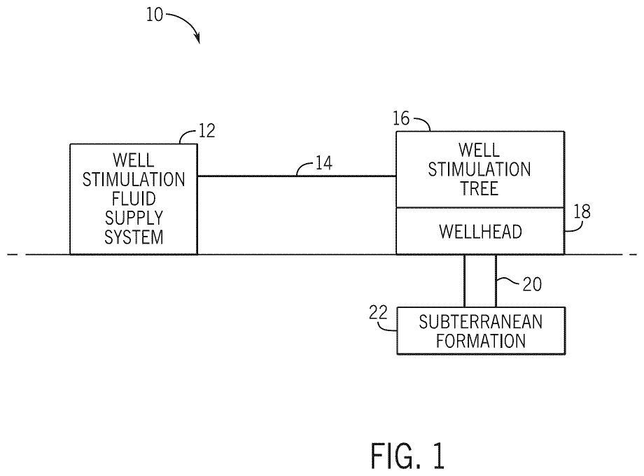

FIG. 1 is a block diagram of an embodiment of a well stimulation system 10. In the illustrated embodiment, the well stimulation system 10 includes a well stimulation fluid supply system 12, a fluid transfer assembly 14, and a well stimulation tree 16. The well stimulation fluid supply system 12 is configured to provide high-pressure fracturing fluid to the fluid transfer assembly 14, and the fluid transfer assembly 14, in turn, is configured to provide the high-pressure fracturing fluid to the well stimulation tree 16. As illustrated, the well stimulation tree 16 is coupled to a wellhead 18, and the well stimulation tree 16 is configured to direct the high-pressure fracturing fluid through the wellhead 18 and a well 20 to a subterranean formation 22. The high-pressure fracturing fluid may fracture the subterranean formation 22 (e.g., by increasing the size of natural fractures, by forming new fractures, etc.). As a result, the production of resources (e.g., hydrocarbon gas, oil, etc.) from the subterranean formation may be increased.

In the illustrated embodiment, the well stimulation system 10 includes a single well stimulation tree 16. However, in other embodiments, the well stimulation system may include multiple well stimulation trees (e.g., 2, 3, 4, or more) and a well stimulation manifold configured to direct the high-pressure fracturing fluid from the fluid transfer assembly to the well stimulation trees. Furthermore, in certain embodiments, the well stimulation system may include multiple well stimulation trees (e.g., 2, 3, 4, or more), and the fluid transfer assembly may be fluidly coupled to each well stimulation tree individually in a cyclical/repeating pattern (e.g., by moving at least a portion of the fluid transfer assembly).

In certain embodiments, the well stimulation fluid supply system 12 includes a fluid source, fluid pumps, and a fluid conduit assembly. The fluid source is configured to output low-pressure fracturing fluid to the fluid conduit assembly, and the fluid conduit assembly is configured to provide the low-pressure fracturing fluid to the fluid pumps. The fluid pumps are configured to significantly increase the pressure and, in certain embodiments, flow rate of the fracturing fluid and to provide the high-pressure fracturing fluid to the fluid conduit assembly. In addition, the fluid conduit assembly is configured to provide the high-pressure fracturing fluid to the fluid transfer assembly.

In certain embodiments, the fluid conduit assembly includes two low-pressure conduit assemblies and a high-pressure conduit assembly. As discussed in detail below, the low-pressure conduit assemblies may be disposed on opposite lateral sides of the high-pressure conduit assembly, and the low-pressure conduit assemblies may be fluidly coupled to an inlet manifold. The inlet manifold may be configured to receive the low-pressure fracturing fluid from the fluid source and to provide the low-pressure fracturing fluid to the low-pressure conduit assemblies. A first low-pressure conduit assembly positioned on a first lateral side of the high-pressure conduit assembly may provide the low-pressure fracturing fluid to a first set of fluid pumps on the first lateral side of the high-pressure conduit assembly, and a second low-pressure conduit assembly positioned on a second lateral side of the high-pressure conduit assembly may provide the fracturing fluid to a second set of fluid pumps on the second lateral side of the high-pressure conduit assembly. As previously discussed, the fluid pumps may significantly increase the pressure of the fracturing fluid, thereby generating high-pressure fracturing fluid. In addition, the fluid pumps may output the high-pressure fracturing fluid to the high-pressure conduit assembly. The high-pressure conduit assembly, in turn, may output the high-pressure fracturing fluid to the fluid transfer assembly.

The fluid supply system may include connection assemblies configured to fluidly couple the fluid pumps to the high-pressure conduit assembly. In certain embodiments, each connection assembly includes a high-pressure flexible hose (e.g., first high-pressure flexible hose) having a first end and a second end. The first end is configured to couple to a high-pressure inlet of the high-pressure conduit assembly. In addition, the connection assembly includes a cart assembly having a cart and an interface assembly. The interface assembly is coupled to the cart, and the interface assembly is configured to couple to the second end of the high-pressure flexible hose such that the cart assembly and the high-pressure conduit assembly support an entirety of the high-pressure flexible hose above a ground surface. Because the entirety of the high-pressure flexible hose is supported above the ground surface, the outer surface of the high-pressure flexible hose may not be abraded by contact with the ground surface, thereby increasing the longevity of the high-pressure flexible hose (e.g., as compared to a high-pressure flexible hose that extends along the ground surface). As a result, the replacement frequency of the high-pressure flexible hoses may be reduced, thereby reducing fluid supply system maintenance costs.

In certain embodiments, at least one connection assembly includes a second high-pressure flexible hose having a first end and a second end. The first end of the second high-pressure flexible hose is configured to couple to a respective fluid pump, and the second end of the second high-pressure flexible hose is configured to couple to the interface assembly such that the cart assembly and the fluid pump support an entirety of the second high-pressure flexible hose above the ground surface. In addition, the second high-pressure flexible hose, the interface assembly, and the first high-pressure flexible hose are configured to establish a fluid flow path from the fluid pump to the high-pressure conduit assembly. Because the entirety of the second high-pressure flexible hose is supported above the ground surface, the outer surface of the second high-pressure flexible hose may not be abraded by contact with the ground surface, thereby increasing the longevity of the second high-pressure flexible hose (e.g., as compared to a high-pressure flexible hose that extends along the ground surface). As a result, the replacement frequency of the second high-pressure flexible hose may be reduced, thereby reducing fluid supply system maintenance costs. Furthermore, because the fluid flow path is established by the interface assembly and two high-pressure flexible hoses, the length of each high-pressure flexible hose may be less than the length of a single high-pressure flexible hose that extends from the fluid pump to the high-pressure conduit assembly. Accordingly, the weight of each high-pressure flexible hose in the embodiment disclosed above may be significantly less than the weight of the single high-pressure flexible hose. As a result, a crane, which may be used to position the single high-pressure flexible hose, may not be utilized to position each high-pressure flexible hose in the embodiment disclosed above, thereby reducing the fluid supply system assembly costs due to obviating purchase or rental of a crane. In addition, because the length of each high-pressure flexible hose may be less than the length of a single high-pressure flexible hose that extends from the fluid pump to the high-pressure conduit assembly, the cost associated with replacing one used high-pressure flexible hose of the multi-hose assembly may be less than the cost of replacing a used single high-pressure flexible hose.

In certain embodiments, at least one connection assembly includes a high-pressure pipe assembly having a first end and a second end. The first end of the high-pressure pipe assembly is configured to couple to a respective fluid pump, and the second end of the high-pressure pipe assembly is configured to couple to the interface assembly such that the cart assembly and the fluid pump support an entirety of the high-pressure pipe assembly above the ground surface. In addition, the high-pressure pipe assembly, the interface assembly, and the high-pressure flexible hose are configured to establish a fluid flow path from the fluid pump to the high-pressure conduit assembly. Because the fluid flow path is established by the high-pressure pipe assembly, the interface assembly, and the high-pressure flexible hose, the length of the high-pressure flexible hose may be less than the length of a high-pressure flexible hose that extends from the fluid pump to the high-pressure conduit assembly. Accordingly, the weight of the high-pressure flexible hose in the embodiment disclosed above may be significantly less than the weight of the single high-pressure flexible hose. As a result, a crane, which may be used to position the single high-pressure flexible hose, may not be utilized to position the high-pressure flexible hose in the embodiment disclosed above, thereby reducing the fluid supply system assembly costs due to obviating purchase or rental of a crane.

While the fluid supply system (e.g., well stimulation fluid supply system) is disclosed herein with regard to a well stimulation system, the fluid supply system (e.g., well fluid supply system), as described herein, may also be employed within any other suitable system configured to provide fluid to a well. For example, in certain embodiments, the fluid supply system (e.g., well intervention fluid supply system) may be employed within a well intervention system. The well intervention system may provide intervention fluid (e.g., including water, acid, sand, proppant, etc.) to a well to further fracture the subterranean formation, thereby increasing production of resources from the well.

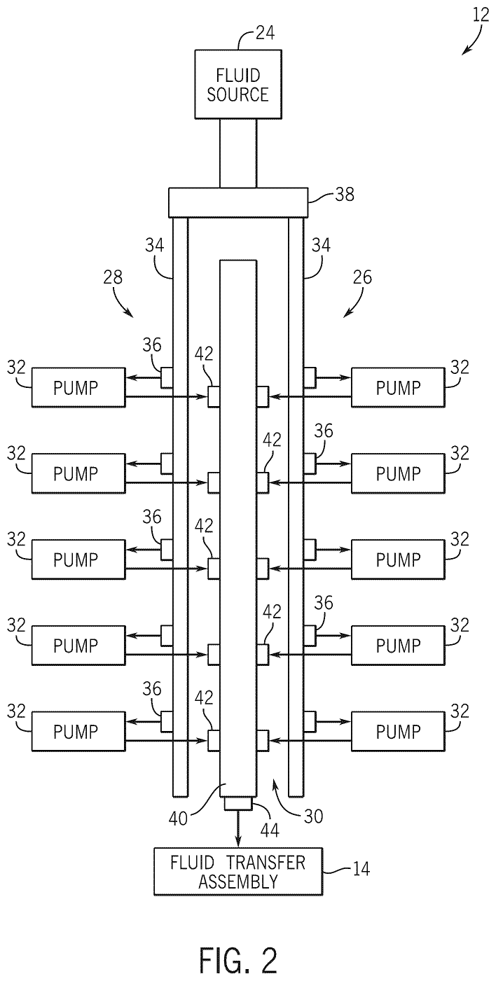

FIG. 2 is a block diagram of an embodiment of a well stimulation fluid supply system 12 that may be employed within the well stimulation system of FIG. 1. In the illustrated embodiment, the well stimulation fluid supply system 12 includes a fluid source 24. The fluid source 24 is configured to output low-pressure fluid (e.g., low-pressure fracturing fluid). The fracturing fluid may include water and proppant (e.g., sand, ceramic particles, etc.). The fracturing fluid may also include one or more chemical additives (e.g., acid, etc.). In certain embodiments, the fluid source 24 includes a water source that may include one or more water tanks, one or more ponds, one or more pumps, other suitable component(s), or a combination thereof. In addition, in certain embodiments, the fluid source 24 includes a blending unit configured to blend the water with the proppant and/or the chemical additives to form the low-pressure fracturing fluid. The blending unit may also include one or more pumps configured to pump the fracturing fluid to the fluid conduit assembly.

In addition, the well stimulation fluid supply system 12 includes a fluid conduit assembly 26 having a low-pressure conduit assembly 28 and a high-pressure monobore conduit assembly 30. The well stimulation fluid supply system 12 also includes multiple fluid pumps 32. The low-pressure conduit assembly 28 is configured to receive the low-pressure fluid (e.g., low-pressure fracturing fluid) from the fluid source 24 and to output the low-pressure fluid to the fluid pumps 32, and the high-pressure monobore conduit assembly 30 is configured to receive the high-pressure fluid (e.g., high-pressure fracturing fluid) from the fluid pumps 32. As previously discussed, each fluid pump 32 is configured to receive the low-pressure fluid, to substantially increase the pressure of the fluid, and to output the high-pressure fluid. In certain embodiments, one or more fluid pumps may be mounted on truck(s), and each truck may position the respective fluid pump(s) at a location suitable for interfacing with the fluid conduit assembly 26. While the well stimulation fluid supply system includes ten pumps in the illustrated embodiment, in other embodiments, the well stimulation fluid supply system may include more or fewer pumps (e.g., 2, 3, 4, 5, 6, 7, 8, 9, 11, 12, etc.).

In the illustrated embodiment, the low-pressure conduit assembly 28 includes low-pressure conduits 34 and low-pressure outlets 36. In addition, the well stimulation fluid supply system 12 includes a manifold 38 configured to direct the low-pressure fluid (e.g., low-pressure fracturing fluid) from the fluid source 24 to the low-pressure conduits 34. For example, the manifold 38 may receive the low-pressure fluid from the fluid source 24 via respective hose(s) and/or pipe(s) (e.g., steel pipe(s), etc.). In addition, the low-pressure outlets 36 are configured to direct the low-pressure fluid from the low-pressure conduits 34 to the fluid pumps 32. For example, the low-pressure outlets 36 may output the low-pressure fluid to the fluid pumps 32 via respective hoses. While the low-pressure conduit assembly 28 includes two low-pressure conduits 34 in the illustrated embodiment, in other embodiments the low-pressure conduit assembly may include more or fewer conduits (e.g., 1, 3, 4, or more). For example, in certain embodiments, the low-pressure conduit assembly may include a single monobore low-pressure conduit. In such embodiments, the manifold may be reconfigured or omitted.

Furthermore, in the illustrated embodiment, the high-pressure monobore conduit assembly 30 includes a high-pressure monobore conduit 40, high-pressure inlets 42, and a high-pressure outlet 44. The high-pressure inlets 42 are configured to direct the high-pressure fluid (e.g., high-pressure fracturing fluid) from the fluid pumps 32 to the high-pressure monobore conduit 40. In addition, the high-pressure outlet 44 is configured to direct the high-pressure fluid toward the well(s) via the fluid transfer assembly 14. As used herein, “monobore conduit” refers to a single respective longitudinal conduit within the fluid conduit assembly, as compared to a multi-bore conduit assembly having two or more longitudinal conduits (e.g., fluidly coupled to one another, such as via u-shaped tube(s), etc.). Accordingly, in the illustrated embodiment, the fluid conduit assembly includes a single high-pressure conduit. However, in other embodiments, the high-pressure conduit assembly may include multiple high-pressure conduits (e.g., 2, 3, 4, or more).

As discussed in detail below, the fluid supply system 12 includes connection assemblies, in which each connection assembly is configured to fluidly couple a respective fluid pump 32 to the high-pressure conduit assembly 30. In certain embodiments, each connection assembly includes a high-pressure flexible hose having a first end and a second end. The first end is configured to couple to a high-pressure inlet 42 of the high-pressure conduit assembly 30. In addition, the connection assembly includes a cart assembly having a cart and an interface assembly. The interface assembly is configured to couple to the second end of the high-pressure flexible hose such that the cart assembly and the high-pressure conduit assembly 30 support an entirety of the high-pressure flexible hose above a ground surface. Because the entirety of the high-pressure flexible hose is supported above the ground surface, the outer surface of the high-pressure flexible hose may not be abraded by contact with the ground surface, thereby increasing the longevity of the high-pressure flexible hose (e.g., as compared to a high-pressure flexible hose that extends along the ground surface). As a result, the replacement frequency of the high-pressure flexible hoses may be reduced, thereby reducing fluid supply system maintenance costs.

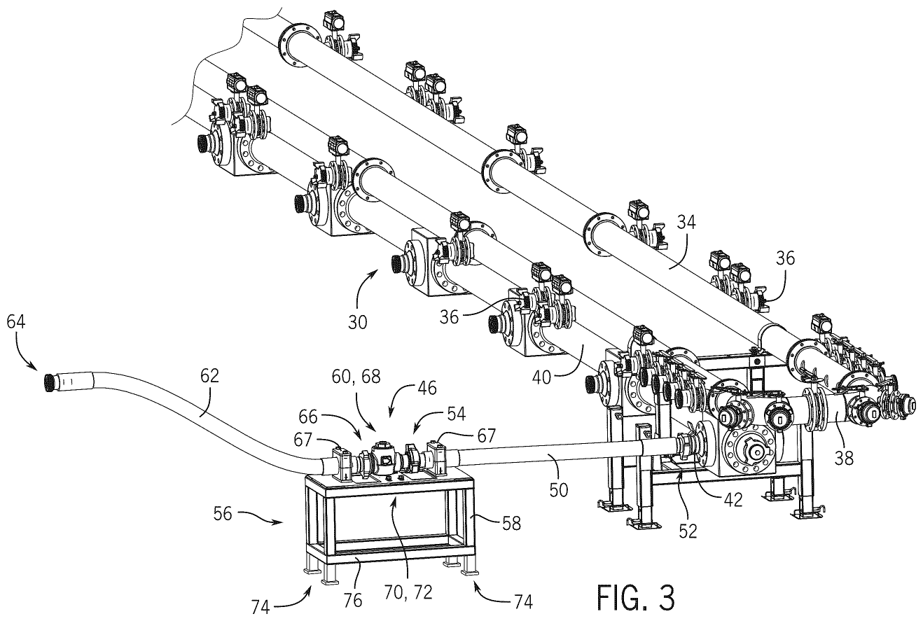

FIG. 3 is a perspective view of an embodiment of a connection assembly 46 that may be employed within the well stimulation fluid supply system of FIG. 2. In the illustrated embodiment, the connection assembly 46 is fluidly coupled to the high-pressure monobore conduit 40 of the high-pressure monobore conduit assembly 30. In the illustrated embodiment, the connection assembly 46 includes a high-pressure flexible hose 50 (e.g., first high-pressure flexible hose 50, high-pressure flow passage, first high-pressure flow passage) having a first end 52 and a second end 54. As illustrated, the first end 52 of the high-pressure flexible hose 50 is coupled to a respective high-pressure inlet 42 of the high-pressure conduit assembly 30. As used herein with regard to high-pressure flexible hoses, “flexible” refers to the ability of the high-pressure flexible hose to bend (e.g., significantly bend) at any location(s) along a length of a body of the high-pressure flexible hose (e.g., exclusive of end connection portions of the high-pressure flexible hose on opposite ends of the body) while maintaining the working pressure rating of the high-pressure flexible hose (e.g., as compared to a substantially rigid high-pressure pipe, a high-pressure pipe assembly formed from multiple substantially rigid high-pressure pipes with one or more joints connecting the pipes, etc.).

The body of the high-pressure flexible hose may be formed from any suitable material or combination of materials that enables the high-pressure flexible hose body to bend. For example, the high-pressure flexible hose body may be formed from a polymeric material (e.g., polyvinyl chloride, polypropylene, polyethylene, etc.). Furthermore, in certain embodiments, the high-pressure flexible hose body may include reinforcing component(s) (e.g., molded within the polymeric material, disposed outside of the polymeric material, etc.), such as woven and/or non-woven wires (e.g., steel wires, stainless steel wires, aluminum wires, etc.), woven and/or non-woven fibers (e.g., carbon fibers, fiberglass fibers, polymeric fibers, ceramic fibers, etc.), etc. In addition, in certain embodiments, the high-pressure flexible hose body may include one or more features configured to increase the flexibility of the flexible body, such as corrugation(s), indentation(s), etc.

Furthermore, in certain embodiments, the high-pressure flexible hose and any other high-pressure flexible hose disclosed herein may be rated for a working pressure of greater than 10,000 psi. For example, in certain embodiments, the high-pressure flexible hose may be rated for a working pressure greater than 10,000 psi, greater than 11,000 psi, greater than 12,000 psi, greater than 13,000 psi, greater than 14,000 psi, greater than 15,000 psi, greater than 16,000 psi, greater than 17,000 psi, greater than 18,000 psi, greater than 19,000 psi, or greater than 20,000 psi. In addition, in certain embodiments, an inner diameter of the high-pressure flexible hose and any other high-pressure flexible hose disclosed herein may be less than or equal to 5 inches (e.g., 12.7 cm). For example, in certain embodiments, the inner diameter of the high-pressure flexible hose may be less than or equal to 4 inches (e.g., 10.16 cm), less than or equal to 3 inches (e.g., 7.62 cm), or less than or equal to 2 inches (e.g., 5.08 cm).

In addition, the high-pressure flexible hose may include any suitable type of connection at each end of the high-pressure flexible hose. For example, in certain embodiments, at least one end (e.g., the first end and/or the second end) of the high-pressure flexible hose may have a threaded connection configured to interface with a corresponding threaded connection of the target object (e.g., the high-pressure inlet, the interface assembly, etc.). Furthermore, in certain embodiments, at least one end (e.g., the first end and/or the second end) of the high-pressure flexible hose may include a collar having a threaded connection configured to interface with a corresponding threaded connection of the target object (e.g., the high-pressure inlet, the interface assembly, etc.). In addition, in certain embodiments, at least one end (e.g., the first end and/or the second end) of the high-pressure flexible hose may include a flange configured to couple to a corresponding flange of the target object (e.g., the high-pressure inlet, the interface assembly, etc.) via clamp(s) and/or fastener(s).

In the illustrated embodiment, the connection assembly 46 includes a cart assembly 56 having a cart 58 and an interface assembly 60. The cart 58 is separate from the high-pressure conduit assembly and the fluid pump, and the interface assembly 60 is coupled to the cart 58. In addition, the interface assembly 60 is configured to couple to the second end 54 of the high-pressure flexible hose 50 such that the cart assembly 56 and the high-pressure conduit assembly 30 support an entirety of the high-pressure flexible hose 50 above a ground surface. Because the entirety of the high-pressure flexible hose 50 is supported above the ground surface, the outer surface of the high-pressure flexible hose may not be abraded by contact with the ground surface, thereby increasing the longevity of the high-pressure flexible hose (e.g., as compared to a high-pressure flexible hose that extends along the ground surface). As a result, the replacement frequency of the high-pressure flexible hoses may be reduced, thereby reducing fluid supply system maintenance costs. While the high-pressure flexible hose 50 is supported above the ground surface in the illustrated embodiment, in other embodiments, at least a portion of the high-pressure flexible hose may be in contact with the ground surface.

In the illustrated embodiment, the connection assembly 46 includes a second high-pressure flexible hose 62 (e.g., high-pressure flow passage) having a first end 64 and a second end 66. The first end 64 of the second high-pressure flexible hose 62 is configured to couple to a fluid pump, and the second end 66 of the second high-pressure flexible hose 62 is configured to couple to the interface assembly 60 such that the cart assembly 56 and the fluid pump support an entirety of the second high-pressure flexible hose 62 above the ground surface. Furthermore, the second high-pressure flexible hose 62, the interface assembly 60, and the first high-pressure flexible hose 50 are configured to establish a fluid flow path from the fluid pump to the high-pressure conduit assembly 30. Accordingly, the high-pressure fracturing fluid may flow from the fluid pump, through the second high-pressure flexible hose 62, through the interface assembly 60, through the first high-pressure flexible hose 50, and into the high-pressure conduit 40 of the high-pressure conduit assembly 30. The second high-pressure flexible hose 62 and any additional high-pressure flexible hoses that facilitate connection(s) between respective fluid pump(s) and the high-pressure conduit assembly may be rated for a working pressure of greater than 10,000 psi, may have an inner diameter of less than or equal to 5 inches (e.g., 12.7 cm), may have a body formed from any suitable material or combination of materials that enables the high-pressure flexible hose body to bend, and may include any suitable type of connection at each end of the high-pressure flexible hose, as disclosed above with reference to the first high-pressure flexible hose 50.

Because the entirety of the second high-pressure flexible hose is supported above the ground surface, the outer surface of the second high-pressure flexible hose may not be abraded by contact with the ground surface, thereby increasing the longevity of the second high-pressure flexible hose (e.g., as compared to a high-pressure flexible hose that extends along the ground surface). As a result, the replacement frequency of the second high-pressure flexible hose(s) may be reduced, thereby reducing fluid supply system maintenance costs. Furthermore, because the fluid flow path is established by the interface assembly and two high-pressure flexible hoses, the length of each high-pressure flexible hose may be less than the length of a single high-pressure flexible hose that extends from the fluid pump to the high-pressure conduit assembly. Accordingly, the weight of each high-pressure flexible hose in the embodiment disclosed above may be significantly less than the weight of the single high-pressure flexible hose. As a result, a crane, which may be used to position the single high-pressure flexible hose, may not be utilized to position each high-pressure flexible hose in the embodiment disclosed above, thereby reducing the fluid supply system assembly costs due to obviating purchase or rental of a crane. While the second high-pressure flexible hose 62 is supported above the ground surface in the illustrated embodiment, in other embodiments, at least a portion of the high-pressure flexible hose may be in contact with the ground surface.

In certain embodiments, the first high-pressure flexible hose 50 may be about 7 feet (e.g., 2.13 m) long, and the second high-pressure flexible hose 62 may be about 7 feet (e.g., 2.13 m) long. However, in other embodiments, the first high-pressure flexible hose and the second high-pressure flexible hose may have any other suitable lengths. For example, in certain embodiments, at least one high-pressure flexible hose may be about 5 feet (e.g., 1.52 m) long, about 6 feet (e.g., 1.83 m) long, about 8 feet (e.g., 2.44 m) long, about 10 feet (e.g., 3.05 m) long, about 13 feet (e.g., 3.96 m) long, about 15 feet (e.g., 4.57 m) long, or about 20 feet (e.g., 6.10 m) long. In certain embodiments, the lengths of the first and second high-pressure flexible hoses may be equal, and in other embodiments, the first high-pressure flexible hose may be longer or shorter than the second high-pressure flexible hose. Because the length of each high-pressure flexible hose may be less than the length of a single high-pressure flexible hose that extends from the fluid pump to the high-pressure conduit assembly, the cost of each high-pressure flexible hose may be reduced, thereby reducing maintenance costs associated with periodically replacing used high-pressure flexible hoses.

As previously discussed, the interface assembly 60 is coupled to the cart 58. The interface assembly 60 may be coupled to the cart 58 by any suitable type(s) of connection(s) (e.g., a clamped connection, a fastener connection, a welded connection, etc.). Furthermore, the interface assembly 60 may be coupled to the cart 58 directly, and/or the interface assembly 60 may be coupled to the cart 58 via the first high-pressure flexible hose 50 and/or the second high-pressure flexible hose 62. For example, in the illustrated embodiment, the first high-pressure flexible hose 50 is coupled to the cart 58 via a first clamp 67, and the second high-pressure flexible hose 62 is coupled to the cart 58 via a second clamp 67. The second end 54 of the first high-pressure flexible hose 50 is coupled to the interface assembly 60, and the second end 66 of the second high-pressure flexible hose 62 is coupled to the interface assembly 60. Accordingly, the interface assembly 60 is coupled to the cart 58 via the first and second high-pressure flexible hoses. However, in other embodiments, the interface assembly may be coupled to the cart via a single high-pressure flexible hose. Furthermore, in certain embodiments, at least one high-pressure flexible hose (e.g., both high-pressure flexible hoses) may be coupled to the cart via other suitable type of connection(s) (e.g., alone or in combination with the clamp(s)), such as fastener connection(s), etc. In embodiments in which the interface assembly is directly coupled to the cart, at least one high-pressure flexible hose (e.g., both high-pressure flexible hoses) may not be coupled to the cart.

In certain embodiments, the interface assembly 60 includes a fluid control device 68 configured to control fluid flow through the interface assembly 60. For example, the fluid control device 68 may control the pressure of the high-pressure fracturing fluid provided to the high-pressure conduit assembly 30, the fluid control device 68 may selectively block fluid flow through the interface assembly 60, the fluid control device 68 may control the fluid flow rate of the high-pressure fracturing fluid through the interface assembly 60, or a combination thereof. In the illustrated embodiment, the fluid control device 68 includes a plug valve 70 configured to selectively block fluid flow through the interface assembly, and the fluid control device 68 includes a check valve 72 configured to block fluid flow from the high-pressure conduit assembly to the fluid pump. The plug valve 70 and the check valve 72 provide two barriers for blocking fluid flow out of the high-pressure conduit assembly, thereby providing redundancy.

While the interface assembly includes the plug valve and the check valve in the illustrated embodiment, in other embodiments, at least one of the valves may be positioned at another suitable location. For example, in certain embodiments, at least one connection assembly may include a check valve configured to couple to the first end of the high-pressure flexible hose (e.g., the first high-pressure flexible hose) and to a respective high-pressure inlet of the high-pressure conduit assembly. As previously discussed, the check valve is configured to block fluid flow from the high-pressure conduit assembly toward the respective fluid pump. In addition, the interface assembly includes the plug valve, which is configured to selectively block fluid flow through the interface assembly. Furthermore, in certain embodiments, the fluid pump may include at least one of the valves (e.g., the plug valve and/or the check valve). In addition, while a plug valve and a check valve are disposed along the fluid flow path between the fluid pump and the high-pressure conduit assembly in the embodiments disclosed above, in certain embodiments, other and/or additional valve(s) may be disposed along the fluid flow path between the fluid pump and the high-pressure conduit assembly. For example, in certain embodiments, other suitable type(s) of valve(s) (e.g., gate valve(s), needle valve(s), etc.) may be disposed along the fluid flow path between the fluid pump and the high-pressure conduit assembly (e.g., alone or in combination with the plug valve and/or the check valve). Furthermore, while two valves disposed along the fluid flow path between the fluid pump and the high-pressure conduit assembly is disclosed above, in certain embodiments, more or fewer valves (e.g., 0, 1, 3, 4, or more) may be disposed along the fluid flow path between the fluid pump and the high-pressure conduit assembly. In embodiments in which the connection assembly includes at least one valve, the number of valves included with the fluid pump/mounted on the truck that provides the fluid pump may be reduced (e.g., to zero), thereby reducing the cost and complexity of the fluid pump/truck. In addition, in certain embodiments, the interface assembly may include any suitable number of valves (e.g., 0, 1, 3, or more). In embodiments in which the interface assembly does not include any valves, the interface assembly may include a conduit (e.g., pipe, flexible hose, etc.) configured to establish a fluid connection between the first high-pressure flexible hose and the second high-pressure flexible hose. Furthermore, as discussed in detail below, the interface assembly may be omitted.

The cart 58 may be formed from any suitable material(s) in any suitable arrangement sufficient to support the weight of the connection assembly 60 and the high-pressure flexible hoses. For example, in certain embodiments, the cart may be formed from multiple metal tubes (e.g., square tubes, round tubes, etc.) coupled to one another (e.g., via welded connection(s), fastener connection(s), adhesive connection(s), etc.). In the illustrated embodiment, the cart 58 has adjustable feet 74 configured to facilitate adjustment of a height and/or an angle of the connection assembly 60 relative to the ground surface. For example, in certain embodiments, a vertical position of each adjustable foot 74 relative to a frame 76 of the cart 58 may be adjusted via a screw-drive mechanism, a hydraulic cylinder, a pin and apertures assembly (e.g., in which a pin is inserted into one of multiple vertically arranged apertures to adjust the position of the foot relative to the frame), other suitable type(s) of adjustment mechanism(s), or a combination thereof. While the cart 58 has adjustable feet 74 in the illustrated embodiment, in other embodiments, the adjustable feet may be omitted (e.g., the frame may engage the ground surface). Because the cart assembly 56 supports the first and second high-pressure flexible hoses, the load(s) (e.g., vertical load, lateral load, etc.) applied to the high-pressure outlet of the fluid pump and the load(s) (e.g., vertical load, lateral load, etc.) applied to the high-pressure inlet 42 of the high-pressure conduit assembly by the respective high-pressure flexible hoses may be reduced (e.g., as compared to the loads applied by a single unsupported high-pressure flexible hose directly connecting the high-pressure outlet of the fluid pump to the high-pressure inlet of the high-pressure conduit assembly).

In certain embodiments, the second high-pressure flexible hose 62 is part of the fluid pump. For example, as previously discussed, the fluid pump may be mounted to a truck. Accordingly, the truck may deliver the fluid pump, including the second high-pressure flexible hose 62, to a suitable location proximate to the respective cart assembly 56. The first end 64 of the second high-pressure flexible hose 62 may be coupled to the high-pressure outlet of the fluid pump during transport to the suitable location. Once the fluid pump is positioned at the suitable location, the second end 66 of the second high-pressure flexible hose 62 may be coupled to the interface assembly 60, thereby establishing the fluid flow path from the high-pressure outlet of the fluid pump to the respective high-pressure inlet 42 of the high-pressure conduit assembly 30. The cart assembly 56 and the first high-pressure flexible hose 50 may be continuously positioned at the high-pressure conduit assembly 30 to facilitate coupling to successive fluid pumps.

Furthermore, in certain embodiments, the cart assembly 56, the first high-pressure flexible hose 50, and the second high-pressure flexible hose 62 may be continuously positioned at the high-pressure conduit assembly to facilitate coupling to successive fluid pumps. Accordingly, the fluid pump may not include the second high-pressure flexible hose 62, and the second end 66 of the second high-pressure flexible hose 62 may be continuously coupled to the interface assembly 60. For example, the truck may deliver the fluid pump to a suitable location proximate to the respective second high-pressure flexible hose 62. The first end 64 of the second high-pressure flexible hose 62 may then be coupled to the high-pressure outlet of the fluid pump, thereby establishing the fluid flow path from the high-pressure outlet of the fluid pump to the respective high-pressure inlet 42 of the high-pressure conduit assembly 30. While the connection assembly 46 includes two high-pressure flexible hoses in the illustrated embodiment, in other embodiments, the connection assembly may include more high-pressure flexible hoses (e.g., 3, 4, 5, or more).

In the illustrated embodiment, the first high-pressure flow passage between the interface assembly 60 and the inlet 42 of the high-pressure conduit assembly 30 includes the first high-pressure flexible hose 50. However, in other embodiments, the first high-pressure flow passage may include a high-pressure pipe assembly having a first end and a second end. The first end of the high-pressure pipe assembly may be configured to couple to the high-pressure inlet of the high-pressure conduit assembly, and the second end of the high-pressure pipe assembly may be configured to couple to the interface assembly 60 (e.g., such that the cart assembly and the high-pressure conduit assembly support an entirety of the high-pressure pipe assembly above the ground surface, such that at least a portion of the high-pressure pipe assembly contacts the ground surface). As used herein with regard to the high-pressure pipe assembly, “pipe” refers to a substantially rigid conduit that is not configured to bend after being manufactured. Furthermore, in certain embodiments, the first high-pressure flow passage may include at least one high-pressure flexible hose and at least one high-pressure pipe assembly. In addition, in certain embodiments, the first high-pressure flow passage may include multiple high-pressure flexible hoses. The first high-pressure flow passage may also include other suitable device(s) configured to facilitate flow of the high-pressure fluid (e.g., alone or in combination with the high-pressure flexible hose(s) and/or the high-pressure pipe assembly/assemblies).

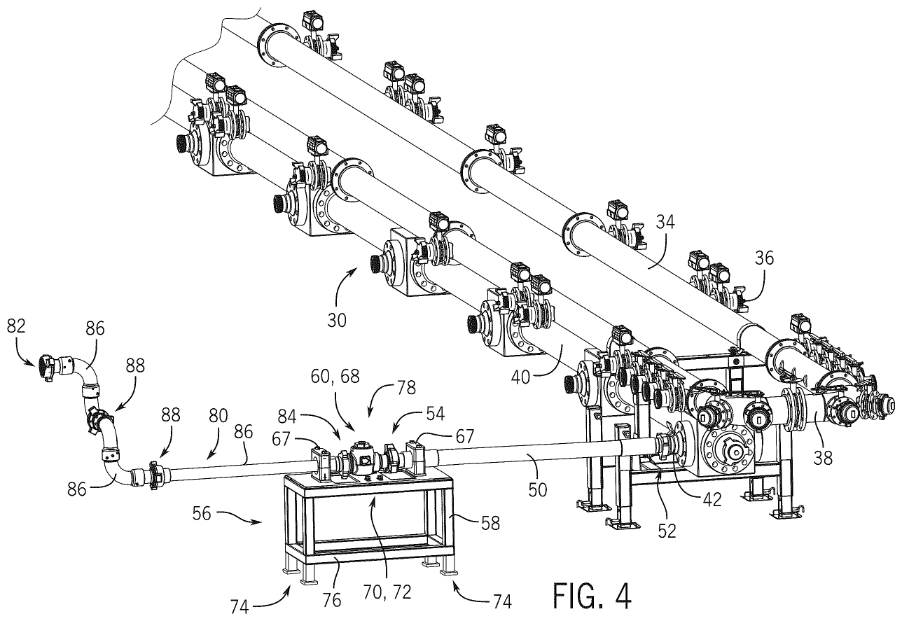

In the illustrated embodiment, the second high-pressure flow passage between the fluid pump and the interface assembly 60 includes the second high-pressure flexible hose 62. However, in other embodiments, such as the embodiment disclosed below with reference to FIG. 4, the second high-pressure flow passage may include a high-pressure pipe assembly having a first end and a second end. The first end of the high-pressure pipe assembly may be configured to couple to the fluid pump, and the second end of the high-pressure pipe assembly may be configured to couple to the interface assembly 60 (e.g., such that the cart assembly and the fluid pump support an entirety of the high-pressure pipe assembly above the ground surface, such that at least a portion of the high-pressure pipe assembly contacts the ground surface). Furthermore, in certain embodiments, the second high-pressure flow passage may include at least one high-pressure flexible hose and at least one high-pressure pipe assembly. In addition, in certain embodiments, the second high-pressure flow passage may include multiple high-pressure flexible hoses. The second high-pressure flow passage may also include other suitable device(s) configured to facilitate flow of the high-pressure fluid (e.g., alone or in combination with the high-pressure flexible hose(s) and/or the high-pressure pipe assembly/assemblies). While one connection assembly is shown in FIG. 3, the fluid supply system may include a connection assembly for each fluid pump/high-pressure conduit assembly inlet. Each connection assembly may include the components disclosed above and have any of the variations/configurations disclosed above. Furthermore, while the connection assembly is positioned on one lateral side (e.g., first lateral side) of the high-pressure conduit assembly in the illustrated embodiment, in other embodiments, at least one connection assembly may be positioned on the opposite lateral side (e.g., second lateral side) of the high-pressure conduit assembly (e.g., alone or in combination with the connection assembly/assemblies positioned on the first lateral side of the high-pressure conduit assembly).

FIG. 4 is a perspective view of another embodiment of a connection assembly 78 that may be employed within the well stimulation fluid supply system of FIG. 2. In the illustrated embodiment, the second high-pressure flow passage includes a high-pressure pipe assembly 80 (e.g., second high-pressure pipe assembly) having a first end 82 and a second end 84. The first end 82 of the high-pressure pipe assembly 80 is configured to couple to a fluid pump, and the second end 84 of the high-pressure pipe assembly 80 is configured to couple to the interface assembly 60 such that the cart assembly 56 and the fluid pump support an entirety of the high-pressure pipe assembly above the ground surface. Furthermore, the high-pressure pipe assembly 80, the interface assembly 60, and the high-pressure flexible hose 50 are configured to establish a fluid path from the fluid pump to the high-pressure conduit assembly 30. Accordingly, the high-pressure fracturing fluid may flow from the fluid pump, through the high-pressure pipe assembly 80, through the interface assembly 60, through the high-pressure flexible hose 50, and into the high-pressure conduit 40 of the high-pressure conduit assembly 30. As previously discussed, with regard to the high-pressure pipe assembly, “pipe” refers to a substantially rigid conduit that is not configured to bend after being manufactured. While the illustrated connection assembly 78 includes the high-pressure pipe assembly 80 instead of the second high-pressure flexible hose disclosed above with reference to FIG. 3, the remaining elements of the connection assembly 78 may be the same as the connection assembly disclosed above with reference to FIG. 3 (e.g., in which like characters represent like elements). Accordingly, any of the details and variations disclosed above with regard to the connection assembly of FIG. 3 may apply to the illustrated connection assembly 78, except with regard to the high-pressure pipe assembly 80.

In the illustrated embodiment, the high-pressure pipe assembly 80 includes multiple pipes 86 coupled to one another by multiple pipe connections 88. In certain embodiments, each pipe 86 may be substantially straight, curved, angled, have another suitable configuration, or include multiple portions having different configurations. Furthermore, each pipe connection 88 may include any suitable type of connection system, such as a threaded connection system, a welded connection system, a collar connection system, another suitable type of connection system, or a combination thereof. While the high-pressure pipe assembly 80 includes multiple pipes 86 in the illustrated embodiment, in other embodiments, the high-pressure pipe assembly may include a single pipe. While the entirety of the high-pressure pipe assembly 80 is supported above the ground surface in the illustrated embodiment, in certain embodiments, at least a portion of the high-pressure pipe assembly may contact the ground surface while the high-pressure pipe assembly is coupled to the fluid pump and to the interface assembly 60.

Furthermore, in certain embodiments, the high-pressure pipe assembly 80 and any other high-pressure pipe assembly disclosed herein may be rated for a working pressure of greater than 10,000 psi. For example, in certain embodiments, the high-pressure pipe assembly may be rated for a working pressure greater than 10,000 psi, greater than 11,000 psi, greater than 12,000 psi, greater than 13,000 psi, greater than 14,000 psi, greater than 15,000 psi, greater than 16,000 psi, greater than 17,000 psi, greater than 18,000 psi, greater than 19,000 psi, or greater than 20,000 psi. In addition, in certain embodiments, an inner diameter of the high-pressure pipe assembly 80 and any other high-pressure pipe assembly disclosed herein may be less than or equal to 5 inches (e.g., 12.7 cm). For example, in certain embodiments, the inner diameter of the high-pressure pipe assembly may be less than or equal to 4 inches (e.g., 10.16 cm), less than or equal to 3 inches (e.g., 7.62 cm), or less than or equal to 2 inches (e.g., 5.08 cm).

Because the fluid flow path is established by the high-pressure pipe assembly, the interface assembly, and the high-pressure flexible hose, the length of the high-pressure flexible hose may be less than the length of a high-pressure flexible hose that extends from the fluid pump to the high-pressure conduit assembly. Accordingly, the weight of the high-pressure flexible hose in the illustrated embodiment may be significantly less than the weight of the single high-pressure flexible hose. As a result, a crane, which may be used to position the single high-pressure flexible hose, may not be utilized to position the high-pressure flexible hose in the illustrated embodiment, thereby reducing the fluid supply system assembly costs due to obviating purchase or rental of a crane. In addition, because the length of the high-pressure flexible hose may be less than the length of a high-pressure flexible hose that extends from the fluid pump to the high-pressure conduit assembly, the cost of the high-pressure flexible hose may be reduced, which may reduce the cost of the fluid supply system and/or reduce maintenance costs associated with periodically replacing high-pressure flexible hoses.

In certain embodiments, the high-pressure pipe assembly is part of the fluid pump. For example, as previously discussed, the fluid pump may be mounted to a truck. Accordingly, the truck may deliver the fluid pump, including the high-pressure pipe assembly, to a suitable location proximate to the respective cart assembly 56. The first end 82 of the high-pressure pipe assembly 80 may be coupled to the high-pressure outlet of the fluid pump during transport to the suitable location. Once the fluid pump is positioned at the suitable location, the second end 84 of the high-pressure pipe assembly 80 may be coupled to the interface assembly 60, thereby establishing the fluid flow path from the high-pressure outlet of the fluid pump to the respective high-pressure inlet of the high-pressure conduit assembly. The cart assembly 56 and the high-pressure flexible hose 50 (e.g., first high-pressure flow passage) may be continuously positioned at the high-pressure conduit assembly to facilitate coupling to successive fluid pumps.

Furthermore, in certain embodiments, the cart assembly 56, the high-pressure flexible hose 50 (e.g., first high-pressure flow passage), and the high-pressure pipe assembly 80 may be continuously positioned at the high-pressure conduit assembly to facilitate coupling to successive fluid pumps. Accordingly, the fluid pump may not include the high-pressure pipe assembly 80, and the second end 84 of the high-pressure pipe assembly 80 may be continuously coupled to the interface assembly 60. For example, the truck may deliver the fluid pump to a suitable location proximate to the respective high-pressure pipe assembly 80. The first end 82 of the high-pressure pipe assembly 80 may then be coupled to the high-pressure outlet of the fluid pump, thereby establishing the fluid flow path from the high-pressure outlet of the fluid pump to the respective high-pressure inlet of the high-pressure conduit assembly. While the high-pressure pipe assembly is disclosed above as either being part of the fluid pump or continuously positioned at the high-pressure conduit assembly, in certain embodiments, a first portion of the high-pressure pipe assembly may be a part of the fluid pump and a second portion of the high-pressure pipe assembly may be continuously positioned at the high-pressure conduit assembly.

In the illustrated embodiment, the first high-pressure flow passage between the interface assembly 60 and the inlet 42 of the high-pressure conduit assembly 30 includes the first high-pressure flexible hose 50. However, in other embodiments, the first high-pressure flow passage may include a high-pressure pipe assembly having a first end and a second end. The first end of the high-pressure pipe assembly may be configured to couple to the high-pressure inlet of the high-pressure conduit assembly, and the second end of the high-pressure pipe assembly may be configured to couple to the interface assembly (e.g., such that the cart assembly and the high-pressure conduit assembly support an entirety of the high-pressure pipe assembly above the ground surface, such that at least a portion of the high-pressure pipe assembly contacts the ground surface). Furthermore, in certain embodiments, the first high-pressure flow passage may include at least one high-pressure flexible hose and at least one high-pressure pipe assembly. In addition, in certain embodiments, the first high-pressure flow passage may include multiple high-pressure flexible hoses. The first high-pressure flow passage may also include other suitable device(s) configured to facilitate flow of the high-pressure fluid (e.g., alone or in combination with the high-pressure flexible hose(s) and/or the high-pressure pipe assembly/assemblies).

In the illustrated embodiment, the second high-pressure flow passage between the fluid pump and the interface assembly 60 includes the high-pressure pipe assembly 80 (e.g., second high-pressure pipe assembly). However, in other embodiments, such as the embodiment disclosed above with reference to FIG. 3, the second high-pressure flow passage may include a high-pressure flexible hose having a first end and a second end. The first end of the high-pressure flexible hose may be configured to couple to the fluid pump, and the second end of the high-pressure flexible hose may be configured to couple to the interface assembly (e.g., such that the cart assembly and the fluid pump support an entirety of the high-pressure flexible hose above the ground surface, such that at least a portion of the high-pressure flexible hose contacts the ground surface). Furthermore, in certain embodiments, the second high-pressure flow passage may include at least one high-pressure flexible hose and at least one high-pressure pipe assembly. In addition, in certain embodiments, the second high-pressure flow passage may include multiple high-pressure flexible hoses. The second high-pressure flow passage may also include other suitable device(s) configured to facilitate flow of the high-pressure fluid (e.g., alone or in combination with the high-pressure flexible hose(s) and/or the high-pressure pipe assembly/assemblies). While one connection assembly is shown in FIG. 4, the fluid supply system may include a connection assembly for each fluid pump/high-pressure conduit assembly inlet. Each connection assembly may include the components disclosed above with respect to FIGS. 3-4 and have any of the variations/configurations disclosed above with respect to FIGS. 3-4. Furthermore, while the connection assembly is positioned on one lateral side (e.g., first lateral side) of the high-pressure conduit assembly in the illustrated embodiment, in other embodiments, at least one connection assembly may be positioned on the opposite lateral side (e.g., second lateral side) of the high-pressure conduit assembly (e.g., alone or in combination with the connection assembly/assemblies positioned on the first lateral side of the high-pressure conduit assembly).

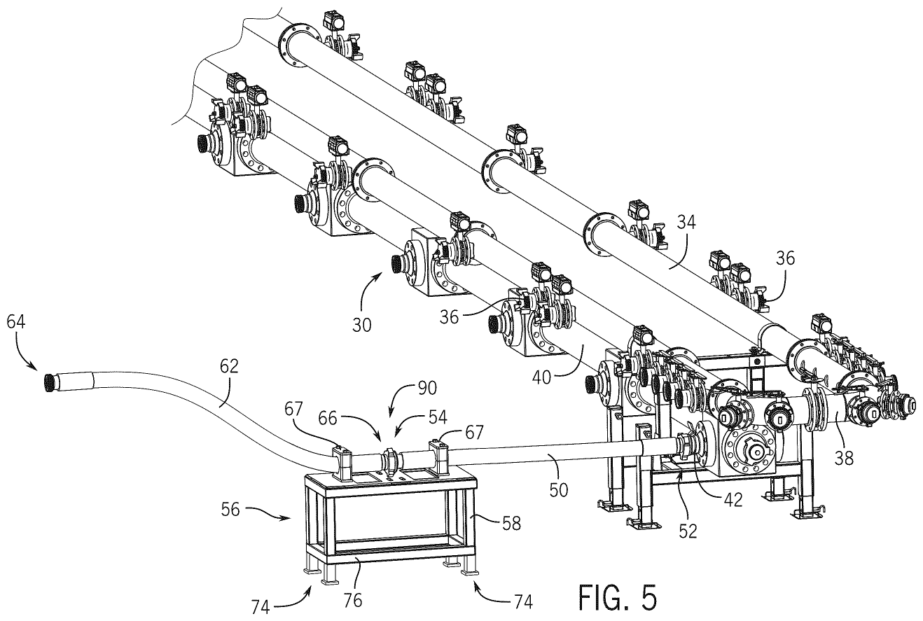

FIG. 5 is a perspective view of a further embodiment of a connection assembly 90 that may be employed within the well stimulation fluid supply system of FIG. 2. In the illustrated embodiment, the interface assembly is omitted (e.g., the cart assembly does not include an interface assembly). Accordingly, the connection assembly 90 includes the first high-pressure flexible hose 50 having the first end 52 and the second end 54. As previously discussed, the first end 52 of the first high-pressure flexible hose 50 is configured to couple to the high-pressure inlet 42 of the high-pressure conduit assembly 30. In addition, the connection assembly 90 includes the second high-pressure flexible hose 62 having the first end 64 and the second end 66. The first end 64 of the second high-pressure flexible hose 62 is configured to couple to the fluid pump, and the second end 66 of the second high-pressure flexible hose 62 is configured to couple to the second end 54 of the first high-pressure flexible hose 50 to establish a fluid flow path from the fluid pump to the high-pressure conduit assembly 30. While the illustrated connection assembly 90 omits the interface assembly, the remaining elements of the connection assembly 90 may be the same as the connection assembly disclosed above with reference to FIG. 3 (e.g., in which like characters represent like elements). Accordingly, any of the details and variations disclosed above with regard to the connection assembly of FIG. 3 may apply to the illustrated connection assembly 90, except with regard to the interface assembly.

As previously discussed, each high-pressure flexible hose may include any suitable type of connection at each end of the high-pressure flexible hose. For example, in certain embodiments, at least one end (e.g., the first end and/or the second end) of the high-pressure flexible hose may have a threaded connection configured to interface with a corresponding threaded connection of the target object (e.g., another high-pressure flexible hose, etc.). Furthermore, in certain embodiments, at least one end (e.g., the first end and/or the second end) of the high-pressure flexible hose may include a collar having a threaded connection configured to interface with a corresponding threaded connection of the target object (e.g., another high-pressure flexible hose, etc.). In addition, in certain embodiments, at least one end (e.g., the first end and/or the second end) of the high-pressure flexible hose may include a flange configured to couple to a corresponding flange of the target object (e.g., another high-pressure flexible hose, etc.) via clamp(s) and/or fastener(s). The second end 66 of the second high-pressure flexible hose 62 may couple to the second end 54 of the first high-pressure flexible hose 50 via any suitable connection, such as any of the connections disclosed above. For example, the second end of one high-pressure flexible hose may include a connector having external threads, and the second end of the other high-pressure flexible hose may have a collar having internal threads. The internal and external threads may be engaged with one another to couple the high-pressure flexible hoses to one another.

In the illustrated embodiment, the connection assembly 90 includes the cart assembly 56. As previously discussed, the cart 58 of the cart assembly 56 is separate from the high-pressure conduit assembly and the fluid pump. Furthermore, in the illustrated embodiment, the first high-pressure flexible hose 50 is coupled to the cart 58 via the first clamp 67, and the second high-pressure flexible hose 62 is coupled to the cart 58 via the second clamp 67. The cart 58 is configured to support the first high-pressure flexible hose 50 and the second high-pressure flexible hose 62 such that the cart 58 of the cart assembly 56, the high-pressure conduit assembly 30, and the fluid pump support an entirety of the first high-pressure flexible hose 50 and the second high-pressure flexible hose 62 above the ground surface. While each high-pressure flexible hose is coupled to the cart 58 via a respective clamp 67 in the illustrated embodiment, in other embodiments, only one high-pressure flexible hose may be coupled to the cart, and the other high-pressure flexible hose may be coupled to the cart via the one high-pressure flexible hose. Furthermore, in certain embodiments, at least one high-pressure flexible hose (e.g., both high-pressure flexible hoses) may be coupled to the cart via other suitable type(s) of connection(s) (e.g., alone or in combination with the clamp(s)), such as fastener connection(s), etc.

Because the fluid flow path between the fluid pump and the high-pressure conduit assembly is established by two high-pressure flexible hoses, the length of each high-pressure flexible hose may be less than the length of a single high-pressure flexible hose that extends from the fluid pump to the high-pressure conduit assembly. Accordingly, the weight of each high-pressure flexible hose in the embodiment disclosed above may be significantly less than the weight of the single high-pressure flexible hose. As a result, a crane, which may be used to position the single high-pressure flexible hose, may not be utilized to position each high-pressure flexible hose in the embodiment disclosed above, thereby reducing the fluid supply system assembly costs due to obviating purchase or rental of a crane. In addition, because the length of each high-pressure flexible hose may be less than the length of a single high-pressure flexible hose that extends from the fluid pump to the high-pressure conduit assembly, the cost associated with replacing one used high-pressure flexible hose of the multi-hose assembly may be less than the cost of replacing a used single high-pressure flexible hose.

In certain embodiments, the lengths of the first and second high-pressure flexible hoses may be equal, and in other embodiments, the first high-pressure flexible hose may be longer or shorter than the second high-pressure flexible hose. While each high-pressure flexible hose is supported above the ground surface in the illustrated embodiment, in other embodiments, at least a portion of at least one high-pressure flexible hose (e.g., both high-pressure flexible hoses) may be in contact with the ground surface. Furthermore, while the connection assembly 90 includes the cart assembly 56 in the illustrated embodiment, in other embodiments, the cart assembly may be omitted. In such embodiments, both high-pressure flexible hoses may be supported above the ground surface by the fluid pump and the high-pressure conduit assembly, or at least one of the high-pressure flexible hoses may be in contact with the ground surface.

In certain embodiments, the second high-pressure flexible hose 62 is part of the fluid pump. For example, as previously discussed, the fluid pump may be mounted to a truck. Accordingly, the truck may deliver the fluid pump, including the second high-pressure flexible hose 62, to a suitable location proximate to the first high-pressure flexible hose 50. The first end 64 of the second high-pressure flexible hose 62 may be coupled to the high-pressure outlet of the fluid pump during transport to the suitable location. Once the fluid pump is positioned at the suitable location, the second end 66 of the second high-pressure flexible hose 62 may be coupled to the second end 54 of the first high-pressure flexible hose 50, thereby establishing the fluid flow path from the high-pressure outlet of the fluid pump to the respective high-pressure inlet 42 of the high-pressure conduit assembly 30. The first high-pressure flexible hose 50 may be continuously positioned at the high-pressure conduit assembly 30 to facilitate coupling to successive fluid pumps.

Furthermore, in certain embodiments, the first high-pressure flexible hose 50 and the second high-pressure flexible hose 62 may be continuously positioned at the high-pressure conduit assembly to facilitate coupling to successive fluid pumps. Accordingly, the fluid pump may not include the second high-pressure flexible hose 62, and the second end 66 of the second high-pressure flexible hose 62 may be continuously coupled to the second end 54 of the first high-pressure flexible hose 50. For example, the truck may deliver the fluid pump to a suitable location proximate to the respective second high-pressure flexible hose 62. The first end 64 of the second high-pressure flexible hose 62 may then be coupled to the high-pressure outlet of the fluid pump, thereby establishing the fluid flow path from the high-pressure outlet of the fluid pump to the respective high-pressure inlet 42 of the high-pressure conduit assembly 30.

While the connection assembly 90 includes two high-pressure flexible hoses in the illustrated embodiment, in other embodiments, the connection assembly may include one or more high-pressure pipe assemblies, and/or the connection assembly may include more or fewer high-pressure flexible hoses. While one connection assembly is shown in FIG. 5, the fluid supply system may include a connection assembly for each fluid pump/high-pressure conduit assembly inlet. Each connection assembly may include the components disclosed above with respect to FIGS. 3-5 and have any of the variations/configurations disclosed above with respect to FIGS. 3-5. Furthermore, while the connection assembly is positioned on one lateral side (e.g., first lateral side) of the high-pressure conduit assembly in the illustrated embodiment, in other embodiments, at least one connection assembly may be positioned on the opposite lateral side (e.g., second lateral side) of the high-pressure conduit assembly (e.g., alone or in combination with the connection assembly/assemblies positioned on the first lateral side of the high-pressure conduit assembly).

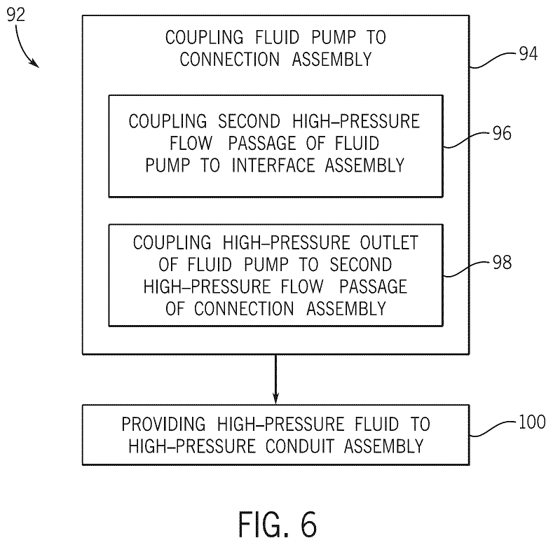

FIG. 6 is a flowchart of an embodiment of a method 92 of providing high-pressure fluid to a high-pressure conduit assembly. First, as represented by block 94, a fluid pump is coupled to a connection assembly. As previously discussed, the connection assembly includes a high-pressure flow passage (e.g., a high-pressure flexible hose and/or a high-pressure pipe assembly) having a first end and a second end. The first end is configured to couple to a high-pressure inlet of the high-pressure conduit assembly. The connection assembly also includes a cart assembly having a cart and an interface assembly. The interface assembly is coupled to the cart, and the interface assembly is configured to couple to the second end of the high-pressure flow passage such that the cart assembly and the high-pressure conduit assembly support an entirety of the high-pressure flow passage above a ground surface. However, in certain embodiments, at least a portion of the high-pressure flow passage may be in contact with the ground surface.

In certain embodiments, a second high-pressure flow passage (e.g., a high-pressure flexible hose and/or a high-pressure pipe assembly) is part of the fluid pump. In such embodiments, coupling the fluid pump to the connection assembly includes coupling the second high-pressure flow passage of the fluid pump to the interface assembly, as represented by block 96. As previously discussed, the second high-pressure flow passage has a first end and a second end. The first end of the second high-pressure flow passage is configured to couple to a high-pressure outlet of the fluid pump, and the second end of the second high-pressure flow passage is configured to couple to the interface assembly such that the cart assembly and the fluid pump support and entirety of the second high-pressure flow passage above the ground surface. However, in certain embodiments, at least a portion of the second high-pressure flow passage may be in contact with the ground surface. In addition, the second high-pressure flow passage, the interface assembly, and the first high-pressure flow passage are configured to establish a fluid flow path from the high-pressure outlet of the fluid pump to the high-pressure conduit assembly. Furthermore, in certain embodiments, the second high-pressure flow passage is not part of the fluid pump. In such embodiments, coupling the fluid pump to the connection assembly includes coupling the high-pressure outlet of the fluid pump to the second high-pressure flow passage of the connection assembly, as represented by block 98. Once the fluid pump is coupled to the connection assembly, high-pressure fluid (e.g., high-pressure fracturing fluid) is provided to the high-pressure conduit assembly via the fluid pump and the connection assembly, as represented by block 100.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A connection assembly for a fluid supply system, comprising:
a high-pressure flow passage having a first end and a second end, wherein the first end is configured to couple to a high-pressure inlet of a high-pressure conduit assembly, and the high-pressure flow passage comprises a high-pressure flexible hose, a high-pressure pipe assembly, or a combination thereof; and
a cart assembly comprising a cart and an interface assembly, wherein the interface assembly is coupled to the cart, and the interface assembly is configured to couple to the second end of the high-pressure flow passage such that the cart assembly and the high-pressure conduit assembly support an entirety of the high-pressure flow passage above a ground surface.

2. The connection assembly of claim 1, comprising a second high-pressure flow passage having a first end and a second end, wherein the first end of the second high-pressure flow passage is configured to couple to a fluid pump, the second end of the second high-pressure flow passage is configured to couple to the interface assembly such that the cart assembly and the fluid pump support an entirety of the second high-pressure flow passage above the ground surface, and the second high-pressure flow passage, the interface assembly, and the high-pressure flow passage are configured to establish a fluid flow path from the fluid pump to the high-pressure conduit assembly.

3. The connection assembly of claim 2, wherein the second high-pressure flow passage comprises a second high-pressure flexible hose, a second high-pressure pipe assembly, or a combination thereof.

4. The connection assembly of claim 3, wherein the high-pressure flow passage comprises the high-pressure flexible hose, and the second high-pressure flow passage comprises the second high-pressure flexible hose.

5. The connection assembly of claim 4, wherein a first length of the high-pressure flexible hose is equal to a second length of the second high-pressure flexible hose.

6. The connection assembly of claim 4, wherein an inner diameter of the high-pressure flexible hose is less than or equal to 5 inches, and an inner diameter of the second high-pressure flexible hose is less than or equal to 5 inches.

7. The connection assembly of claim 3, wherein the second high-pressure flow passage comprises the second high-pressure pipe assembly, and the second high-pressure pipe assembly comprises a plurality of pipes coupled to one another by a plurality of pipe connections.

8. The connection assembly of claim 1, wherein the interface assembly comprises a fluid control device configured to control fluid flow through the interface assembly.

9. The connection assembly of claim 8, wherein the fluid control device comprises a plug valve configured to selectively block fluid flow through the interface assembly.

10. The connection assembly of claim 8, wherein the fluid control device comprises a check valve configured to block fluid flow from the high-pressure conduit assembly toward a fluid pump.

11. The connection assembly of claim 1, wherein the high-pressure flow passage is rated for a working pressure of greater than 10,000 psi.

12. A method of providing high-pressure fluid to a high-pressure conduit assembly, comprising:
coupling a fluid pump to a connection assembly, wherein the connection assembly comprises:
a high-pressure flow passage having a first end and a second end, wherein the first end is configured to couple to a high-pressure inlet of the high-pressure conduit assembly, and the high-pressure flow passage comprises a high-pressure flexible hose, a high-pressure pipe assembly, or a combination thereof; and
a cart assembly comprising a cart and an interface assembly, wherein the interface assembly is coupled to the cart, and the interface assembly is configured to couple to the second end of the high-pressure flow passage such that the cart assembly and the high-pressure conduit assembly support an entirety of the high-pressure flow passage above a ground surface; and
providing, via the fluid pump and the connection assembly, the high-pressure fluid to the high-pressure conduit assembly.

13. The method of claim 12, wherein coupling the fluid pump to the connection assembly comprises coupling a second high-pressure flow passage of the fluid pump to the interface assembly, wherein the second high-pressure flow passage has a first end and a second end, the first end of the second high-pressure flow passage is configured to couple to a high-pressure outlet of the fluid pump, the second end of the second high-pressure flow passage is configured to couple to the interface assembly such that the cart assembly and the fluid pump support an entirety of the second high-pressure flow passage above the ground surface, and the second high-pressure flow passage, the interface assembly, and the high-pressure flow passage are configured to establish a fluid flow path from the high-pressure outlet of the fluid pump to the high-pressure conduit assembly.

14. The method of claim 13, wherein the second high-pressure flow passage comprises a second high-pressure flexible hose, a second high-pressure pipe assembly, or a combination thereof.

15. The method of claim 12, wherein coupling the fluid pump to the connection assembly comprises coupling a high-pressure outlet of the fluid pump to a second high-pressure flow passage of the connection assembly, wherein the second high-pressure flow passage has a first end and a second end, the first end of the second high-pressure flow passage is configured to couple to the high-pressure outlet of the fluid pump, the second end of the second high-pressure flow passage is configured to couple to the interface assembly such that the cart assembly and the fluid pump support an entirety of the second high-pressure flow passage above the ground surface, and the second high-pressure flow passage, the interface assembly, and the high-pressure flow passage are configured to establish a fluid flow path from the high-pressure outlet of the fluid pump to the high-pressure conduit assembly.

16. The method of claim 15, wherein the second high-pressure flow passage comprises a second high-pressure flexible hose, a second high-pressure pipe assembly, or a combination thereof.

17. A connection assembly for a fluid supply system, comprising:
a first high-pressure flexible hose having a first end and a second end, wherein the first end is configured to couple to a high-pressure inlet of a high-pressure conduit assembly; and
a second high-pressure flexible hose having a first end and a second end, wherein the first end of the second high-pressure flexible hose is configured to couple to a fluid pump, and the second end of the second high-pressure flexible hose is configured to couple to the second end of the first high-pressure flexible hose to establish a fluid flow path from the fluid pump to the high-pressure conduit assembly.

18. The connection assembly of claim 17, comprising a cart configured to support the first high-pressure flexible hose and the second high-pressure flexible hose such that the cart, the high-pressure conduit assembly, and the fluid pump support an entirety of the first high-pressure flexible hose and the second high-pressure flexible hose above a ground surface.

19. The connection assembly of claim 17, wherein a first length of the first high-pressure flexible hose is equal to a second length of the second high-pressure flexible hose.

20. The connection assembly of claim 17, wherein the first high-pressure flexible hose is rated for a working pressure of greater than 10,000 psi, and the second high-pressure flexible hose is rated for a working pressure of greater than 10,000 psi.
